(19) United States
(12) Patent Application Publication
(10) Pub. No.: US 2023/0328832 A1
(43) Pub. Date: Oct. 12, 2023

(54) INTEGRATED ACCESS AND BACKHAUL TIMING MODE SIGNALING

(71) Applicant: Samsung Electronics Co., Ltd., Suwon-si (KR)

(72) Inventors: Milos TESANOVIC, Staines (GB); Seunghoon CHOI, Suwon-si (KR)

(21) Appl. No.: 18/191,500

(22) Filed: Mar. 28, 2023

(30) Foreign Application Priority Data
Apr. 5, 2022 (GB) 2205001.7
Feb. 22, 2023 (GB) 2302554.7

(51) Int. Cl. H04W 52/36; H04W 76/20

(52) U.S. Cl. CPC H04W 76/20; H04W 52/367; H04W 80/02

(57) ABSTRACT

The disclosure relates to a 5^{th} Generation (5G) or 6^{th} Generation (6G) communication system for supporting a higher data transmission rate. A method for a first node in a wireless communication system is provided. The method includes receiving, from a second node, a radio resource control (RRC) message including information on a list of slots, receiving, from the second node, a medium access control (MAC) control element (CE) indicating at least one timing mode to be applied to at least one slot in the list of slots, and identifying, based on the MAC CE, the at least one timing mode corresponding to the at least one slot.

### CROSS-REFERENCE TO RELATED APPLICATION(S)

This application is based on and claims priority under 35 U.S.C. § 119(a) of a United Kingdom patent application number 2205001.7, filed on Apr. 5, 2022, in the United Kingdom Intellectual Property Office, and of a United Kingdom patent application number 2302554.7, filed on Feb. 22, 2023, in the United Kingdom Intellectual Property Office, the disclosure of each of which is incorporated by reference herein in its entirety.

### BACKGROUND

### 1. Field

The disclosure relates to signaling of timing modes between nodes (e.g., parent and child nodes). More particularly, the disclosure relates to a network incorporating integrated access and backhaul (IAB), for example within 3^{rd} generation partnership project (3GPP) 5^{th} generation (5G) new radio (NR) and (at least in part) NR-based relay networks.

### 2. Description of Related Art

5G mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement 6th Generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mm Wave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In 3^{rd} generation partnership project (3GPP) 5^{th} generation (5G) new radio (NR), integrated access and backhaul (IAB) is a technique for providing wireless backhaul as an alternative to a fiber backhaul network. An IAB network comprises IAB nodes, at which wireless resources are shared between wireless backhaul and access links. Due to the limited coverage area of an IAB node, the backhaul network is typically implemented as a multi-hop network with backhaul traffic traversing multiple IAB nodes.

3GPP 5G Release 16 has been frozen and work on finalizing Release 17 is currently underway. An aim of Release 17 is to develop and improve features relating to IAB relative to the Release 16 baseline.

FIG. 1 shows a two-hop IAB network as described in 3GPP NR Rel-16 and further enhanced in Rel-17 according to the related art.

As described in 3GPP technical specification (TS) 38.213 v17.0.0, for a serving cell of an IAB-mobile termination (MT), the IAB-MT can be provided by its parent IAB-distributed unit (DU) with a timing case indication an indication of the IAB-MT transmission timing mode in a slot. If the indicated IAB-MT transmission timing mode in a slot is set to Case-1, the IAB-MT transmission time is determined as for a “regular” UE. If the indicated IAB-MT transmission timing mode in a slot is set to Case-6, the IAB-node sets the IAB-MT transmission time to the transmission time of the IAB-DU. If the indicated IAB-MT transmission timing mode in a slot is set to Case-7, the IAB-MT is provided a timing advance offset value for a serving cell.

The following is the description of the timing case indication agreed by RAN1 at their RAN1#108-e meeting (February 2022):

The parent-node indicates to an IAB-node a list of slots and their associated uplink (UL) transmit (TX) timing cases (i.e., one of {Case 1, Case 6, Case 7} for each slot).

The value range as agreed and communicated by RAN1 is as follows:

{Case 1, Case 6, Case 7} per slot, for a number of slots. The list of slots can have the following ranges for periodicity: {16, 20, 32, 40, 64, 80, 160, 320, 640, 1280, 2560, 5120} slots.

Design and implementation of signaling to achieve this is still under discussion.

The above information is presented as background information only to assist with an understanding of the disclosure. No determination has been made, and no assertion is made, as to whether any of the above might be applicable as prior art with respect to the disclosure.

### SUMMARY

Aspects of the disclosure are to address at least the above-mentioned problems and/or disadvantages and to provide at least the advantages described below. Accordingly, an aspect of the disclosure is to provide a 5^{th} generation (5G) or 6^{th} generation (6G) communication system for supporting a higher data transmission rate.

Additional aspects will be set forth in part in the description which follows and, in part, will be apparent from the description, or may be learned by practice of the presented embodiments.

In accordance with an aspect of the disclosure, a first node in a wireless communication system is provided. The first node includes a transceiver, and at least one processor coupled to the transceiver and configured to receive, from a second node, an RRC message including information on a list of slots, receive, from the second node, a MAC CE indicating at least one timing mode to be applied to at least one slot in the list of slots, and identify, based on the MAC CE, the at least one timing mode corresponding to the at least one slot.

In accordance with another aspect of the disclosure, a second node in a wireless communication system is provided. The second node includes a transceiver, and at least one processor coupled to the transceiver and configured to transmit, to a first node, an RRC message including information on a list of slots, and transmit, to the first node, a MAC CE indicating at least one timing mode to be applied to at least one slot in the list of slots, wherein the at least one timing mode corresponding to the at least one slot is identified based on the MAC CE.

In accordance with another aspect of the disclosure, a method for a first network entity in a network is provided. The method includes receiving first signaling including, for one or more slots, information associated with transmission, and performing an operation relating to transmission based on the information associated with transmission, wherein the one or more slots are indicated in second signaling between the first network entity and a second network entity in the network, and wherein the second signaling and the first signaling are signaled through a combination of radio resource control (RRC) signaling and medium access channel (MAC) control element (CE) signaling.

In accordance with another aspect of the disclosure, a method of the first example, wherein the second signaling is provided. The method includes a slot index for each of the one or more slots, and/or wherein the one or more slots are not consecutive.

In accordance with another aspect of the disclosure, a method of the first example or the second example, is provided. The method further includes receiving, from the second network entity, the second signaling indicating the one or more slots.

In accordance with another aspect of the disclosure, a method of the third example, wherein the information associated with transmission is provided. The method includes at least one timing mode, a downlink (DL) transmit (TX) power adjustment value, or information on restricted beam indication for integrated access and backhaul (IAB)-distributed unit (DU).

In accordance with another aspect of the disclosure, a method of the fourth example, wherein performing the operation is provided. The method includes applying, for at least one of the one or more slots, a timing mode, among the at least one timing mode, applying the DL TX power adjustment value for a transmission in at least one of the one of more slots, or applying the information on restricted beam indication for IAB-DU for a transmission in at least one of the one or more slots.

In accordance with another aspect of the disclosure, a method of the fourth example or the fifth example, wherein each of the at least one timing mode is indicated, in the first signaling, by two bits, and/or wherein each of the at least one timing mode is one of Case-1, Case-7 or Case-7 is provided.

In accordance with another aspect of the disclosure, a method of any of the fourth to sixth examples, wherein the second signaling is provided. The method further includes an indication of a periodicity with which a mapping between the at least one timing mode and at least one of the one or more slots is repeated.

In accordance with another aspect of the disclosure, a method of the seventh example, wherein the indication of the periodicity is longer than the one or more slots is provided.

In accordance with another aspect of the disclosure, a method of the first example or the second example, is provided. The method further includes transmitting, to the second network entity, the second signaling indicating the one or more slots.

In accordance with another aspect of the disclosure, a method of the ninth example, wherein the information associated with transmission is provided. The method includes a desired downlink (DL) transmit (TX) power adjustment value for each of the one or more slots, information on restricted beam indication for integrated access and backhaul (IAB)-mobile termination (MT), or a desired IAB-MT power spectral density range.

In accordance with another aspect of the disclosure, a method of the tenth example, wherein performing the operation is provided. The method includes using the desired DL TX power adjustment value in a resource allocation procedure applicable to a transmission operation of the second network entity for at least one of the one of more slots, and transmitting a DL TX power adjustment value to the second network entity based on the resource allocation procedure, using the information on recommended restricted beam indication for IAB-MT in a resource allocation procedure applicable to a transmission operation of the second network entity for at least one of the one of more slots, and transmitting a restricted beam indication to the second network entity based on the resource allocation procedure, or using the desired IAB-MT power spectral density range in a power control procedure for the second network entity for at least one of the one or more slots. In various examples, the resource allocation procedure is the operation relating to transmission. In various examples, the power allocation procedure is the operation relating to transmission.

In accordance with another aspect of the disclosure, a method of any previous example, wherein the first signaling is provided. The method further includes an indication of the one or more slots to which the information associated with transmission applies.

In accordance with another aspect of the disclosure, a method of any previous example, wherein the first signaling is received through MAC CE signaling and the second signaling is received through RRC signaling is provided.

In accordance with another aspect of the disclosure, a method for a second network entity in a network is provided. The method includes transmitting, to a first network entity, first signaling including, for one or more slots, information associated with transmission, wherein the one or more slots are indicated in second signaling between the first network entity and the second network entity, and wherein the second signaling and the first signaling are signaled through a combination of RRC, signaling and MAC, CE, signaling.

In accordance with another aspect of the disclosure, a method of the fourteenth example is provided. The method further includes transmitting the second signaling indicating the one or more slots to the first network entity.

In accordance with another aspect of the disclosure, a method of the fifteenth example, wherein the information associated with transmission is provided. The method includes at least one timing mode, a downlink (DL) transmit (TX) power adjustment value, or information on restricted beam indication for integrated access and backhaul (IAB)-distributed unit (DU).

In accordance with another aspect of the disclosure, a method of the fifteenth example or the sixteenth example, wherein each of the at least one timing mode is indicated, in the first signaling, by two bits, and/or wherein each of the at least one timing mode is one of Case-1, Case-7 or Case-7 is provided.

In accordance with another aspect of the disclosure, a method of the sixteenth example or the seventeenth example, wherein the second signaling is provided. The method further includes an indication of a periodicity with which a mapping between the at least one timing mode and at least one of the one or more slots is repeated.

In accordance with another aspect of the disclosure, a method of the eighteenth example, wherein the indication of the periodicity is longer than the one or more slots is provided.

In accordance with another aspect of the disclosure, a method of the fourteenth example is provided. The method further includes receiving the second signaling indicating the one or more slots from the first network entity.

In accordance with another aspect of the disclosure, a method of the twentieth example, wherein the information associated with transmission is provided. The method includes a desired downlink (DL) transmit (TX) power adjustment value for each of the one or more slots, information on restricted beam indication for integrated access and backhaul (IAB)-mobile termination (MT), or a desired IAB-MT power spectral density range.

In accordance with another aspect of the disclosure, a method of the any of the fourteenth to twenty-first examples, wherein the second signaling is provided. The method includes a slot index for each of the one or more slots, and/or wherein the one or more slots are not consecutive.

In accordance with another aspect of the disclosure, a method of any previous example, wherein at least one of the network is a 5G NR network, the first network entity is one of an integrated access and backhaul (IAB) child node or an IAB parent node, and the second network entity is the other one of the IAB child node or the IAB parent node is provided.

In accordance with another aspect of the disclosure, a network entity configured to operate according to the method of any of the first to twenty-third examples is provided.

In accordance with another aspect of the disclosure, a computer program is provided. The computer program includes instructions which, when the program is executed by a computer or processor, cause the computer or processor to carry out a method according to any of the first to twenty-third examples.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an architecture for multi-hop backhauling (source 3^{rd} generation partnership project (3GPP) technical report (TR) 38.874) according to the related art;

FIG. 2 is a block diagram of a network entity that may be used according to an embodiment of the disclosure;

FIG. 3 illustrates a method flow according to an embodiment of the disclosure;

FIG. 4 illustrates a block diagram illustrating a structure of a user equipment (UE) according to an embodiment of the disclosure; and

FIG. 5 illustrates a block diagram illustrating a structure of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following examples are applicable to, and use terminology associated with, 3^{rd} generation partnership project (3GPP) 5^{th} generation (5G). However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G new radio (NR) or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of an IAB node in the examples below may be applied to any other suitable type of entity performing functions of a network node.

The skilled person will appreciate that certain examples of the disclosure may not be directly related to standardization but rather proprietary implementation of some of the integrated access and backhaul (IAB) functions or non-IAB related functions of NR Rel-17 and beyond networks.

The skilled person will appreciate that the disclosure is not limited to the specific examples disclosed herein. For example:

The techniques disclosed herein are not limited to 3GPP 5G.

The techniques disclosed herein are not limited to IAB or relay networks.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements, entities and/or messages may be added to the examples disclosed herein.

One or more non-essential elements, entities and/or messages may be omitted in certain examples.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed may be modified, if possible, in alternative examples.

The transmission of information between network entities is not limited to the specific form, type and/or order of messages described in relation to the examples disclosed herein.

To satisfy extremely high data rate requirements, the 3GPP 5G NR standard utilizes communication frequencies in a relatively high range, from 30 GHz to 300 GHz, corresponding to wavelengths in the millimeter (mm) range (mmWave communication). Such mmWave communication provides a large available bandwidth and high transmission speeds. However, problems with mmWave communication include severe signal path loss and low penetration, resulting in a relatively short transmission range. This in turn requires a greater density of base stations deployment.

Due to the relatively high cost and other difficulties associated with deployment of fiber transport network links, wireless backhauling can be used as an alternative. IAB, in which a part of the radio resources is used for backhauling, is standardized in 3GPP Rel-16.

According to 3GPP TR 38.874, the backhaul architecture supports multi-hop backhauling in which backhaul traffic is wirelessly relayed by network nodes via one or more hops with some hops using mmWave communication in certain deployments. Multi-hop backhauling provides more range extension than single hop. This is especially beneficial for above-6GHz frequencies due to their limited range. Multi-hop backhauling further enables backhauling around obstacles, e.g., buildings in urban environment for in-clutter deployments.

In addition, according to TR 38.874, IAB reuses existing functions and interfaces defined for access. More particularly, mobile-termination (MT), g Node B (gNB)-DU, gNB-central unit (CU), UPF, access and mobility management function (AMF) and session management function (SMF) as well as the corresponding interfaces NR Uu (between MT and gNB), F1, NG, X2 and N4 are used as baseline for the IAB architectures.

The MT function has been defined as a component of the mobile equipment, and is referred to as a function residing on an IAB-node that terminates the radio interface layers of the backhaul Uu interface toward the IAB-donor or other IAB-nodes.

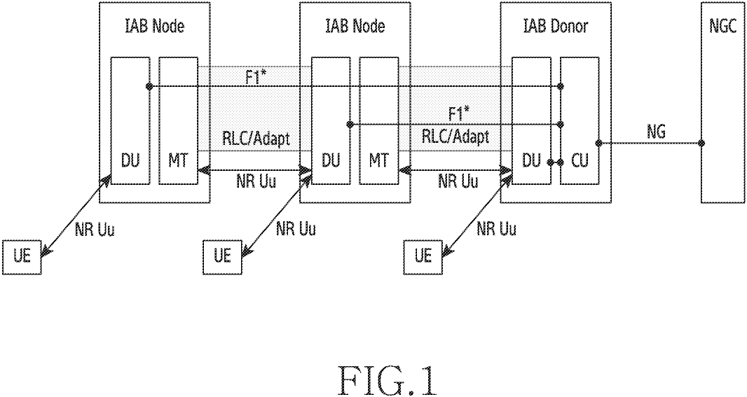

FIG. 1 illustrates an architecture for multi-hop backhauling defined in TR 38.874, showing the reference diagram for a two-hop chain of IAB-nodes underneath an IAB-donor, where IAB-node and UE connect in stand-alone (SA)-mode to a next generation core (NGC) according to the related art.

An IAB-node may be defined as a radio access network (RAN) node that supports wireless access to UEs and wirelessly backhauls the access traffic. An IAB-donor may be defined as a RAN node which provides UE’s interface to core network and wireless backhauling functionality to IAB-nodes.

The architecture of FIG. 1 leverages CU/DU-split architecture. That is, the IAB donor node comprises a central unit (CU) and one or more distributed units (DUs), with an interface called F1 between them. The functionality of the IAB donor is divided between the CU (hosting radio resource control (RRC), service data adaption protocol (SDAP) and packet data conversion protocol (PDCP), and which terminates the F1 interface connected with the DU) and DU (hosting radio link control (RLC), medium access control (MAC) and physical (PHY) layers, and which terminates the F1 interface with the CU) logical nodes. The internal structure (CU/DU) of the IAB donor is not visible to other nodes and the 5G core network (5GC). See 3GPP TS 38.401.

In the architecture of FIG. 1, each IAB-node holds a DU and an MT. Via the MT, the IAB-node connects to an upstream IAB-node or the IAB-donor. Via the DU, the IAB-node establishes RLC-channels to UEs and to MTs of downstream IAB-nodes. For MTs, this RLC-channel may refer to a modified RLC*. An IAB-node can connect to more than one upstream IAB-node or IAB-donor DU. The IAB-node may contain multiple DUs, but each DU part of the IAB-node has F1-C connection only with one IAB-donor CU-CP.

The donor also holds a DU to support UEs and MTs of downstream IAB-nodes. The IAB-donor holds a CU for the DUs of all IAB-nodes and for its own DU. It is assumed that the DUs on an IAB-node are served by only one IAB-donor. This IAB-donor may change through topology adaptation. Each DU on an IAB-node connects to the CU in the IAB-donor using a modified form of F1, which is referred to as F1 *. F1 *-U runs over RLC channels on the wireless backhaul between the MT on the serving IAB-node and the DU on the donor. An adaptation layer is added — named backhaul adaptation layer (BAP) - which performs bearer mapping and routing. It replaces the IP functionality of the standard F1-stack. F1*-U may carry a GTP-U header for the end-to-end association between CU and DU.

The Uu interface represents the interface between the UE and the DU in an IAB node. The F1 * interface represents the interface between the IAB DU and an upstream CU.

Various examples of the disclosure provide techniques for signaling of timing modes between the parent IAB node and the child IAB node. More particularly, certain examples may provide techniques defining a mapping between a list of slots and timing modes. Certain examples may provide different solutions for the signaling of this mapping, and for the design of mapping itself. The skilled person will appreciate that the application of the signaling techniques described herein is not limited to IAB or the specific information described in the specific examples.

In certain examples, it is assumed that the slots to which the signaled information applies need not be consecutive. In this case, certain examples may signal the slot indices to which the indicated timing modes apply. For example, the mapping may be defined by N pairs of (K₁ bits, K₂ bits), where K₁ indicates a slot index and K₂ indicates one of timing modes. As an example, N pairs of (13 bits, 2 bits) fields may be signaled, covering N≥1 slots (not necessarily consecutive). The 13-bit field is used to indicate the index of the slot to which the timing mode (indicated in the 2-bit field) applies. The lengths of these individual fields may vary, for example if the number of timing modes exceeds 4, or if a different indication of the time instant (to which the timing mode applies) other than the slot index, for example as defined in TS 38.213 and/or TS 38.473, is used.

In cases where slots are not consecutive, certain examples may specify which timing modes apply to the slots not covered by the N indicated slots. In certain examples, it is assumed that a default case (or e.g., RRC-signaled case) applies to all such slots, e.g., Case-1.

In certain examples, N pairs of (13 bits, 1 bit) fields are signaled, covering N slots (not necessarily consecutive), and M pairs of (13 bits, 1 bit) fields are also signaled, covering N slots (not necessarily consecutive) and M slots (not necessarily consecutive), respectively. The 13-bit field is used to indicate the index of the slot to which the timing mode (indicated in the 1-bit field) applies. It is further assumed that in slots not explicitly indicated a third timing mode applies (e.g., only signal N slots to which Case-6 applies, and M slots to which Case-7 mode applies, and the receiving node may infer that Case-1 mode will apply to any and all slots not explicitly indicated, within the range of the earliest indicated slot to the latest indicated slot). The skilled person will appreciate that the numerical values (e.g., 13 and 1) are merely exemplary.

In certain examples, the timing mode may stay the same during the Mᵢ consecutive slots, starting from the i-^{th} signaled slot index. For example, the following may be signaled:

Slot index i, number Mᵢ representing number of consecutive slots, and 2-bit field indicating the timing mode applicable to the Mᵢ consecutive slots.

This is then repeated, and the total number of slots covered is Σ Mᵢ = N. The slots may be consecutive within batches (e.g., each of length Mᵢ), while the end slot of one batch and the beginning slot of the next batch may or may not be consecutive. If the latter holds, the receiving node may infer that a pre-defined (or e.g., RRC configured) timing mode (e.g., Case-1 mode) will apply to any and all slots not explicitly indicated.

In certain examples, it is assumed that the slots to which the signaled information applies are consecutive. In this case, certain examples may signal the starting slot index (from which the indicated timing modes apply). This may then be followed by N 2-bit fields, each indicating the timing mode that applies to the relevant time slot.

In certain examples, it is assumed that the slots to which the signaled information applies are consecutive, and that the same timing mode applies to all of them. In this case, certain examples may signal the starting slot index (from which the indicated timing modes apply), followed by a single 2-bit value indicating the timing mode which applies to all the N time slots.

Certain examples may signal the value N.

In certain examples, no signaling of the starting slot index is assumed. The starting slot index may instead be inferred by the receiving node, e.g., assumed to be to the first upcoming slot with system frame number (SFN) = 0, or assumed to be the slot which is P slots in the future (where P can be pre-configured or e.g., RRC signaled).

In certain examples (e.g., the above examples) it is assumed that the signaling is done via a MAC control element (CE). However, in various examples the signaling may be done via RRC signaling instead, or through a combination of both RRC signaling and MAC CE. The following are examples of how the latter option may be done:

A block of slots may be configured via RRC to which a specific pre-determined or signaled timing mode (e.g., Case-1) applies, and then MAC CE signaling may be used according to one or more of the examples above to indicate to which of those slots other timing modes (e.g., Case-6 or Case-7 timing mode) should apply (i.e., MAC CE overrides the semi-static RRC configuration).

The periodicity with which the timing mode mapping is repeated may be configured via RRC, while the mapping may be signaled via MAC CE(s), according to one or more of the examples above.

A set of slots may be configured via RRC which are to be used as starting slots, and the timing mode mapping may be configured via MAC CE according to one or more of the examples above and assumed by the node to apply from one of the starting slots signaled by the RRC (e.g., the first such slot following reception of the MAC CE, the N^{th} such slot, the N^{th} such slot following reception of the MAC CE for which SFN = 0 applies, or the like).

The full configuration (timing mode mapping to slots, plus optionally periodicity) may be done via RRC, according to one or more of the examples above, and it may be activated via a MAC CE (i.e., applied upon reception of a pre-defined MAC CE e.g., containing an activation bit) (and possibly also deactivated, or it is deactivated after a certain pre-defined or signaled number of repetitions, or the expiry of a timer).

The full configuration (timing mode mapping to slots, plus optionally periodicity) may be done via MAC CE(s), according to one or more of the examples above, and it may be activated via RRC (and possibly also deactivated, or it is deactivated after a certain pre-defined or signaled number of repetitions, or the expiry of a timer).

The periodicity may be equal to the length of the list of slots (i.e., all slots to which the mapping applies, regardless of whether each slot index is explicitly signaled), or not equal. For example, periodicity may be longer that the list of slots, and the assumption may be that a default timing mode (e.g., Case-1) is applied between two repetitions of the mapping.

In certain examples, the indication of timing modes and its mapping to a time axis (e.g., slots) is assumed. In certain examples, instead of (or in addition to) the indication of timing modes, an indication of one or more of the following information may be provided, and optionally mapped to a time axis (e.g., slots) as in one or more of the examples above:

Information on restricted beam indication for IAB-DU sent from the parent-node to child node: signaling from an IAB-node/IAB-donor to a child node indicating beams of the child IAB-DU in the direction of which simultaneous operation is restricted, information identifying said child IAB-DU restricted beams including (but not limited to) synchronization signal block (SSB) identification (ID) (and additionally SSB transmission configuration (STC) index, if needed) and/or channel state information reference signal (CSI-RS) ID.

Information on restricted beam indication for IAB-MT sent from an IAB node to the parent node signaling from an IAB-node to its parent-node indicating the recommended beams of the IAB-MT for DL receive (RX) beams and/or UL TX beams, information identifying said beams including (but not limited to) DL transmission configuration indication (TCI) state ID and RS ID (SSB ID and/or CSI-RS ID) for DL RX beam(s) indication, and SRI for UL TX beam(s) indication.

Desired DL TX power adjustment values sent from the IAB node to the parent-node, including (but not limited to) the information sent by the IAB-MT indicating to its parent-node, its desired DL TX power adjustment to assist with the parent-node’s DL TX power allocation.

DL TX power adjustment values from the parent-node to the IAB node, including (but not limited to) information sent by the parent-node indicating to the IAB-node an adjustment to the parent-node’s DL TX power (e.g., in response to receiving Desired DL TX Power Adjustment from the IAB-node).

Desired IAB-MT power spectral density (PSD) range sent from the IAB node to the parent-node, including (but not limited to) information sent by the IAB-node indicating to its parent-node, its desired PSD range to help with its MT’s UL TX power control.

Certain examples of the disclosure provide a first network entity (e.g., an IAB-DU, an IAB-Donor-DU or an IAB-MT) configured to operate according to a method according to any example, embodiment of the disclosure, aspect and/or claim disclosed herein.

Certain examples of the disclosure provide a second network entity (e.g., an IAB-DU, an IAB-Donor-DU or an IAB-MT) configured to cooperate with a first network entity of the preceding example according to any example, embodiment of the disclosure, aspect and/or claim disclosed herein.

Certain examples of the disclosure provide a network (e.g., IAB network) or wireless communication system comprising a first network entity and a second network entity according to any example, embodiment of the disclosure, aspect and/or claim disclosed herein.

Certain examples of the disclosure provide a computer program comprising instructions which, when the program is executed by a computer or processor, cause the computer or processor to carry out a method according to any example, embodiment of the disclosure, aspect and/or claim disclosed herein.

Certain examples of the disclosure provide a computer or processor-readable data carrier having stored thereon a computer program according to the preceding examples.

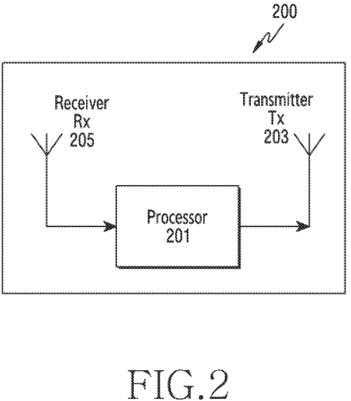

FIG. 2 is a block diagram of a network entity (e.g., IAB Node or IAB Donor) that may be used according to an embodiment of the disclosure. The skilled person will appreciate that the network entity illustrated in FIG. 2 may be implemented, for example, as a network element on a dedicated hardware, as a software instance running on a dedicated hardware, or as a virtualized function instantiated on an appropriate platform, e.g., on a cloud infrastructure.

An entity 200 comprises a processor (or controller) 201, a transmitter 203 and a receiver 205. The receiver 205 is configured for receiving one or more messages from one or more other network entities. The transmitter 203 is configured for transmitting one or more messages to one or more other network entities. The processor 201 is configured for performing operations as described above.

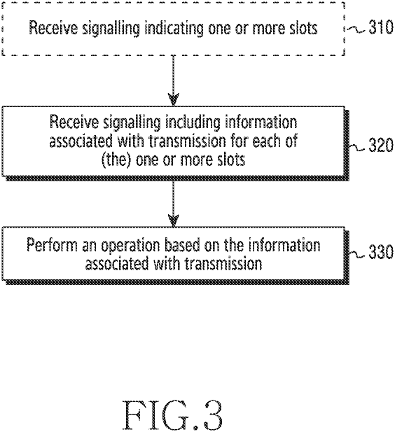

FIG. 3 shows a method flow according to an embodiment of the disclosure.

Operation 310 is optionally performed. In various examples, operation 310 may be performed when a first network entity is a downstream IAB node, a child IAB node, or IAB-MT of a downstream/child IAB node. In operation 310, a first network entity may receive second signaling indicating one or more slots from a second network entity (e.g., if operation 310 is performed this may be an upstream IAB node, a parent IAB node, an IAB-donor or IAB-DU of an upstream/parent node). For example, the second signaling may include or otherwise indicate a slot index for one or more slots. Optionally, the second signaling may include information on periodicity with which the timing mode mapping for the slots is repeated, and in certain examples the periodicity is longer than the list of slots (e.g., the values of entries in a list of slots included in the second signaling may be less than the value of the periodicity, or the number of entries in a list of slots included in the second signaling may be smaller than the value of the periodicity).

In operation 320, the first network entity may receive first signaling comprising information associated with transmission (or configuration information, or mapping information, or, more generally, information). The second signaling may be received from a/the second network entity. The information associated with transmission may include information for each of the one or more slots, or information for one or some (e.g., a subset) of the one or more slots.

For example, the first signaling may indicate a timing mode, e.g., using two bits, the first signaling may indicate a desired DL TX power adjustment value(s), and/or the first signaling may include information on restricted beam indication for IAB-DU (e.g., if the first network entity is a downstream IAB node, a child IAB node, or IAB-MT, and/or if the second network entity is an upstream IAB node, a parent IAB node, an IAB-donor or IAB-DU).

For example, two bits may be used in the first signaling to indicate a timing mode for a corresponding slot. In a further example: a value of ‘00’ may be used to indicate a timing mode is Case-1, a value of ‘01’ may be used to indicate a timing mode is Case-6, and a value of ‘10’ may be used to indicate a timing mode is Case-7.

In other examples, the first signaling may indicate a DL TX power adjustment value(s), information on restricted beam indication for IAB-MT, and/or information on a desired IAB-MT power spectral density range (e.g., if the first network entity is an upstream IAB node, a parent IAB node, an IAB-donor or IAB-DU, and/or if the second network entity is a downstream IAB node, a child IAB node, or IAB-MT).

In operation 330, the first network entity may perform an operation (e.g., an operation relating to transmission) based on the information associated with transmission. For example, the operation may relate to the one or more slots, or at least a portion thereof. For example, the first network entity may apply the information associated with transmission to each of the one or more slots. For example, the first network entity may configure a slot based on the information in the first signaling for that slot, configure a transmission in a slot based on the information in the first signaling for that slot, apply the information in the first signaling to a corresponding slot, make a determination relating to a transmission in a slot based on the information in the first signaling for that slot, or use the information in processing relating to the slot etc.

For example, for the case of the information comprising at least one timing mode each mapped to a slot indicated in the second signaling, the first network entity (e.g., a downstream IAB node, a child IAB node, or IAB-MT) may apply the corresponding timing mode to each slot according to.

In another example, for the case of the information comprising a DL TX power adjustment value, the first network entity (e.g., a downstream IAB node, a child IAB node, or IAB-MT) may configure a slot, or a transmission in the slot, based on the DL TX power adjustment value.

In another example, for the case of the information comprising information on restricted beam indication for IAB-DU, the first network entity (e.g., a downstream IAB node, a child IAB node, or IAB-MT) may apply the information on restricted beam indication for IAB-DU for a transmission in at least one of the one or more slots.

In another example, for the case of the information comprising a desired DL TX power adjustment value, the first network entity (e.g., an upstream IAB node, a parent IAB node, a IAB-donor or IAB-DU) may use the information in power allocation (e.g., determining power allocation relating to a corresponding slot), and, optionally, may transmit information (e.g., a DL TX power adjustment value) to the second network entity based on the result of the power allocation. For instance, the first network entity may use the desired DL TX power adjustment value in a resource allocation procedure applicable to a transmission operation of the second network entity for at least one of the one of more slots, and, optionally, transmit a DL TX power adjustment value to the second network entity based on the resource allocation procedure. Here, an example of a resource allocation procedure may be a power allocation procedure. Here, the “operation relating to transmission” refers to the first network entity performing an operation which will influence a transmission by the second network entity, such as performing a power allocation procedure which may influence or affect transmission(s) by the second network entity.

In another example, for the case of the information comprising information on restricted beam indication for IAB-MT, the first network entity (e.g., an upstream IAB node, a parent IAB node, a IAB-donor or IAB-DU) may use the information on recommended restricted beam indication for IAB-MT in a resource allocation procedure applicable to a transmission operation of the second network entity for at least one of the one of more slots, and, optionally, transmit a restricted beam indication to the second network entity based on the resource allocation procedure. Here, an example of a resource allocation procedure may be a power allocation procedure.

In another example, for the case of the information comprising a desired IAB-MT power spectral density range, the first network entity (e.g., an upstream IAB node, a parent IAB node, a IAB-donor or IAB-DU) may use the desired IAB-MT power spectral density range in a resource control procedure for the second network entity for at least one of the one or more slots. Here, an example of a resource allocation procedure may be a power allocation procedure.

In certain embodiments of the disclosure, operation 330 is optionally performed. For example, at least one of operation 310 or operation 330 may be omitted.

It will be appreciated that the first signaling may be received before, after or at substantially the same time as the second signaling. In some examples, the second signaling and the first signaling is done through a combination of RRC signaling and MAC CE signaling. For example, a block of slots may be signaled via RRC, and MAC CE signaling may be used to indicate, to the first network entity, information associated with transmission (e.g., timing modes, desired DL TX power adjustment values, or DL TX power adjustment values) for at least one/some/all of the slots in the block of slots.

It will be appreciated that various embodiments of the disclosure include a second network entity performing the operations indicated in the description of FIG. 3, e.g., complementing the operations performed by the disclosed first network entity or otherwise interacting with the disclosed first network entity.

Certain examples of the disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the disclosure may be provided in the form of a system (e.g., a network) comprising one or more such apparatuses/devices/network entities, and/or a method therefor. For example, in the following examples, a network may include one or more IAB nodes.

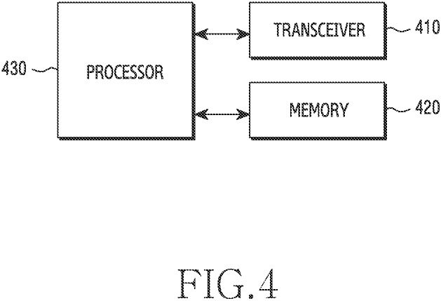

FIG. 4 illustrates a block diagram illustrating a structure of a UE according to an embodiment of the disclosure.

Referring to 4, the UE according to an embodiment may include a transceiver 410, a memory 420, and a processor 430. The transceiver 410, the memory 420, and the processor 430 of the UE may operate according to a communication method of the UE described above. However, the components of the UE are not limited thereto. For example, the UE may include more or fewer components than those described above. In addition, the processor 430, the transceiver 410, and the memory 420 may be implemented as a single chip. In addition, the processor 430 may include at least one processor.

The transceiver 410 collectively refers to a UE receiver and a UE transmitter, and may transmit/receive a signal to/from a base station or a network entity. The signal transmitted or received to or from the base station or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

In addition, the transceiver 410 may receive and output, to the processor 430, a signal through a wireless channel, and transmit a signal output from the processor 430 through the wireless channel.

The memory 420 may store a program and data required for operations of the UE. In addition, the memory 420 may store control information or data included in a signal obtained by the UE. The memory 420 may be a storage medium, such as a read-only memory (ROM), a random access memory (RAM), a hard disk, a compact disc read only memory (CD-ROM), and a digital versatile disc (DVD), or a combination of storage media.

The processor 430 may control a series of processes such that the UE operates as described above. For example, the transceiver 410 may receive a data signal including a control signal transmitted by the base station or the network entity, and the processor 430 may determine a result of receiving the control signal and the data signal transmitted by the base station or the network entity.

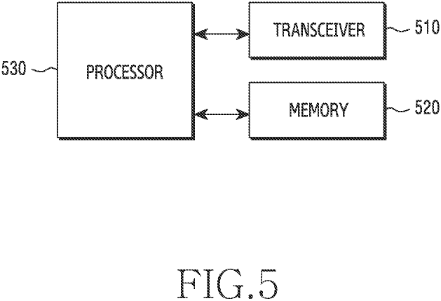

FIG. 5 illustrates a block diagram illustrating a structure of a network entity (for example, base station, IAB Node or IAB Donor) according to an embodiment of the disclosure. FIG. 5 corresponds to the example of the network entity of FIG. 3.

Referring to FIG. 5, the network entity according to an embodiment may include a transceiver 510, a memory 520, and a processor 530. The transceiver 510, the memory 520, and the processor 530 of the network entity may operate according to a communication method of the network entity described above. However, the components of the network entity are not limited thereto. For example, the network entity may include more or fewer components than those described above. In addition, the processor 530, the transceiver 510, and the memory 520 may be implemented as a single chip. In addition, the processor 530 may include at least one processor.

The transceiver 510 collectively refers to a network entity receiver and a network entity transmitter, and may transmit/receive a signal to/from a terminal or a base station. The signal transmitted or received to or from the terminal or a base station may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

In addition, the transceiver 510 may receive and output, to the processor 530, a signal through a wireless channel, and transmit a signal output from the processor 530 through the wireless channel.

The memory 520 may store a program and data required for operations of the network entity. In addition, the memory 520 may store control information or data included in a signal obtained by the network entity. The memory 520 may be a storage medium, such as a ROM, a RAM, a hard disk, a CD-ROM, and a DVD, or a combination of storage media.

The processor 530 may control a series of processes such that the network entity operates as described above. For example, the transceiver 510 may receive a data signal including a control signal transmitted by the terminal, and the processor 530 may determine a result of receiving the control signal and the data signal transmitted by the terminal.

According to various embodiments of the disclosure, a first node in a wireless communication system is provided. The first node including a transceiver, and at least one processor coupled to the transceiver and configured to receive, from a second node, an RRC message including information on a list of slots, receive, from the second node, a MAC CE indicating at least one timing mode to be applied to at least one slot in the list of slots, and identify, based on the MAC CE, the at least one timing mode corresponding to the at least one slot.

In one embodiment of the disclosure, wherein one or more slots in the list of slots are not consecutive.

In one embodiment of the disclosure, wherein the RRC message further includes information on a periodicity of the list of slots.

In one embodiment of the disclosure, wherein a size of the list of slots is less than a size of the periodicity.

In one embodiment of the disclosure, wherein a length of a field for indicating the at least one timing mode is 2 bits.

In one embodiment of the disclosure, wherein the controller is further configured to: transmit, to the second node, a MAC CE including information on a desired DL Tx power adjustment associated with the RRC message, and receive, from the second node, a MAC CE including information on a DL Tx power adjustment associated with the RRC message.

According to various embodiments of the disclosure, a second node in a wireless communication system is provided. The second node including a transceiver, and at least one processor coupled to the transceiver and configured to transmit, to a first node, an RRC message including information on a list of slots, and transmit, to the first node, a MAC CE indicating at least one timing mode to be applied to at least one slot in the list of slots, wherein the at least one timing mode corresponding to the at least one slot is identified based on the MAC CE.

In one embodiment of the disclosure, wherein one or more slots in the list of slots are not consecutive.

In one embodiment of the disclosure, wherein the RRC message further includes information on a periodicity of the list of slots.

In one embodiment of the disclosure, wherein a size of the list of slots is less than a size of the periodicity.

In one embodiment of the disclosure, wherein a length of a field for indicating the at least one timing mode is 2 bits.

In one embodiment of the disclosure, wherein the controller is further configured to: receive, from the first node, a MAC CE including information on a desired DL Tx power adjustment associated with the RRC message, and transmit, to the first node, a MAC CE including information on a DL Tx power adjustment associated with the RRC message.

According to various embodiments of the disclosure, a method performed by a first node in a wireless communication system, the method comprising receiving, from a second node, an RRC message including information on a list of slots, receiving, from the second node, a MAC CE indicating at least one timing mode to be applied to at least one slot in the list of slots, and identifying, based on the MAC CE, the at least one timing mode corresponding to the at least one slot.

In one embodiment of the disclosure, wherein one or more slots in the list of slots are not consecutive.

In one embodiment of the disclosure, wherein the RRC message further includes information on a periodicity of the list of slots.

It will be appreciated that examples of the disclosure may be realized in the form of hardware, software or a combination of hardware and software. Certain examples of the disclosure may provide a computer program comprising instructions or code which, when executed, implement a method, system and/or apparatus in accordance with any aspect, claim, example and/or embodiment disclosed herein. Certain embodiments of the disclosure provide a machine-readable storage storing such a program.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the disclosure.

The terms and words used herein are not limited to the bibliographical or standard meanings, but, are merely used to enable a clear and consistent understanding of the examples disclosed herein.

Throughout the description and claims, the words “comprise”, “contain” and “include”, and variations thereof, for example “comprising”, “containing” and “including”, means “including but not limited to”, and is not intended to (and does not) exclude other features, elements, components, integers, steps, processes, functions, characteristics, and the like.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. A first node in a wireless communication system, the first node comprising:
a transceiver; and
at least one processor coupled to the transceiver and configured to:
receive, from a second node, a radio resource control (RRC) message including information on a list of slots,
receive, from the second node, a medium access control (MAC) control element (CE) indicating at least one timing mode to be applied to at least one slot in the list of slots, and
identify, based on the MAC CE, the at least one timing mode corresponding to the at least one slot.

2. The first node of claim 1, wherein one or more slots in the list of slots are not consecutive.

3. The first node of claim 1, wherein the RRC message further includes information on a periodicity of the list of slots.

4. The first node of claim 3, wherein a size of the list of slots is less than a size of the periodicity.

5. The first node of claim 1, wherein a length of a field for indicating the at least one timing mode is 2 bits.

6. The first node of claim 1, wherein the at least one processor is further configured to:
transmit, to the second node, a MAC CE including information on a desired downlink (DL) transmit (Tx) power adjustment associated with the RRC message and
receive, from the second node, a MAC CE including information on a DL Tx power adjustment associated with the RRC message.

7. A second node in a wireless communication system, the second node comprising:
a transceiver; and
at least one processor coupled to the transceiver and configured to:
transmit, to a first node, a radio resource control (RRC) message including information on a list of slots, and
transmit, to the first node, a medium access control (MAC) control element (CE) indicating at least one timing mode to be applied to at least one slot in the list of slots,
wherein the at least one timing mode corresponding to the at least one slot is identified based on the MAC CE.

8. The second node of claim 7, wherein one or more slots in the list of slots are not consecutive.

9. The second node of claim 8, wherein the RRC message further includes information on a periodicity of the list of slots.

10. The second node of claim 9, wherein a size of the list of slots is less than a size of the periodicity.

11. The second node of claim 7, wherein a length of a field for indicating the at least one timing mode is 2 bits.

12. The second node of claim 7, wherein the at least one processor is further configured to:
receive, from the first node, a MAC CE including information on a desired downlink (DL) transmit (Tx) power adjustment associated with the RRC message; and
transmit, to the first node, a MAC CE including information on a DL Tx power adjustment associated with the RRC message.

13. A method performed by a first node in a wireless communication system, the method comprising:
receiving, from a second node, a radio resource control (RRC) message including information on a list of slots;
receiving, from the second node, a medium access control (MAC) control element (CE) indicating at least one timing mode to be applied to at least one slot in the list of slots; and
identifying, based on the MAC CE, the at least one timing mode corresponding to the at least one slot.

14. The method of claim 13, wherein one or more slots in the list of slots are not consecutive.

15. The method of claim 13, wherein the RRC message further includes information on a periodicity of the list of slots.

16. The method of claim 15, wherein a size of the list of slots is less than a size of the periodicity.

17. The method of claim 13, wherein a length of a field for indicating the at least one timing mode is 2 bits.

18. The method of claim 13, further comprising:
transmitting, to the second node, a MAC CE including information on a desired downlink (DL) transmit (Tx) power adjustment associated with the RRC message, and
receiving, from the second node, a MAC CE including information on a DL Tx power adjustment associated with the RRC message.
